(19) United States
(12) Patent Application Publication
(10) Pub. No.: US 2008/0102806 A1
(43) Pub. Date: May 1, 2008

(54) System and method for providing caller information service in mobile communication terminal

(76) Inventors: Jung Ran Lee, Chilgok-gun (KR); Yun Seo Choi, Goyang-si (KR)

Correspondence Address: CHA & REITER, LLC, 210 ROUTE 4 EAST STE 103, PARAMUS, NJ, 07652, US

(21) Appl. No.: 11/823,301

(22) Filed: Jun. 26, 2007

(30) Foreign Application Priority Data
Oct. 31, 2006 (KR) 2006-0105974

(51) Int. Cl. H04M 3/42

(52) U.S. Cl. 455/415

(57) ABSTRACT

A method and system for providing a caller information service in a mobile communication terminal is disclosed. The method enables viewing and modification of caller information stored on a network while providing the caller information service. The method for providing a caller information service includes requesting caller information containing a calling name registered on a network, receiving the caller information from the network and displaying the caller information, entering a new calling name to replace the calling name, transmitting the new calling name to the network and receiving a signal indicating the completion of information modification from the network. The method and system further enables a user to view subscription/no subscription status to the caller information service and to view a calling name based on caller information received from the network, and enable the user to easily modify the calling name into a desired calling name for registration.

### CLAIM OF PRIORITY

This application claims the benefit of the earlier filing date, pursuant to 35 USC 119, to that patent application entitled “SYSTEM AND METHOD FOR PROVIDING CALLER INFORMATION SERVICE IN MOBILE COMMUNICATION TERMINAL” filed in the Korean Intellectual Property Office on Oct. 31, 2006 and assigned Serial No. 2006-0105974, the contents of which are incorporated herein by reference.

### BACKGROUND OF THE INVENTION

1. Field of the Invention

The present invention relates to mobile communication, and more particularly, to a method and system for providing a caller information service in a mobile communication terminal that enables viewing and modification of caller information stored on a network while providing the caller information service.

2. Description of the Related Art

With rapid advancement of mobile communications services, mobile communication terminals have developed from simple tools used to make and receive phone calls and provide Short Message Service (SMS) into multimedia devices offering a wide variety of supplementary services, including video calls, Internet access, and content playback services.

Supplementary services that can provide caller information to users include Calling Number Identification Presentation (CNIP) specified by Interim Standard 41 Revision (IS-41C) and Calling Name Presentation (CNAP) recommended by the wireless intelligent network standard IS-771, for example.

The CNAP is a supplementary service that enables a mobile communication terminal user to transmit a calling name or a context associated with a call pre-registered with a network (hereinafter referred to as “calling name information”) to a called party's mobile communication terminal while originating a call, thus permitting the called party to view the calling name information.

However, a conventional CNAP service has a drawback in that a calling party cannot view calling name information stored on a network while permitting a called party to view the calling name information. Thus, the calling party needs to check with a service provider about the calling name information or view the calling name information through the Internet, thus causing user inconvenience. Thus, there is a need for a method for viewing and modifying calling name information in a simple manner using a mobile communication terminal.

### SUMMARY OF THE INVENTION

In order to solve the above problems, a system and method for providing a caller information service in a mobile communication terminal that enable easy viewing and modification of caller information being transmitted to a called party.

According to an exemplary embodiment of the present invention, there is provided a method for providing a caller information service in a mobile communication terminal, including requesting caller information containing a calling name registered on a network, receiving the caller information from the network and displaying the caller information.

In accordance with another exemplary embodiment of the present invention, there is provided a system for providing a caller information service, including a mobile communication terminal for requesting previously registered caller information and modification of a calling name contained in the caller information, a name database (NDB) having a database containing the caller information, wherein the NDB extracts and transmits a calling name associated with the mobile communication terminal upon receiving a request for the caller information, and modifies the calling name according to a request to modify the calling name and stores a new calling name and a mobile switching center (MSC) for relaying a signal transmitted between the mobile communication terminal and the NDB, and for checking whether the mobile communication terminal subscribes to the caller information service according to the request received from the mobile communication terminal for the caller information to be transmitted to the mobile communication terminal.

Preferably, the caller information includes information indicating whether a subscription or no subscription to the caller information service (for example, a Calling Name Presentation (CNAP) service) is known.

### BRIEF DESCRIPTION OF THE DRAWINGS

The features and advantages of the present invention will be more apparent from the following detailed description in conjunction with the accompanying drawings, in which:

FIG. 1 schematically illustrates a flow of signals in a method for providing a caller information service according to an exemplary embodiment of the present invention;

FIG. 2 illustrates a system for providing a caller information service according to another exemplary embodiment of the present invention;

FIG. 3 is a flowchart illustrating a method for providing a caller information service according to another exemplary embodiment of the present invention; and

FIG. 4 is a flowchart illustrating a method for providing a caller information service in a mobile communication terminal according to another exemplary embodiment of the present invention.

### DETAILED DESCRIPTION OF THE INVENTION

Hereinafter, embodiments of the present invention are described in detail with reference to the accompanying drawings. For the purposes of clarity and simplicity, detailed descriptions of constructions or processes known in the art may be omitted to avoid obscuring the subject matter of the present invention.

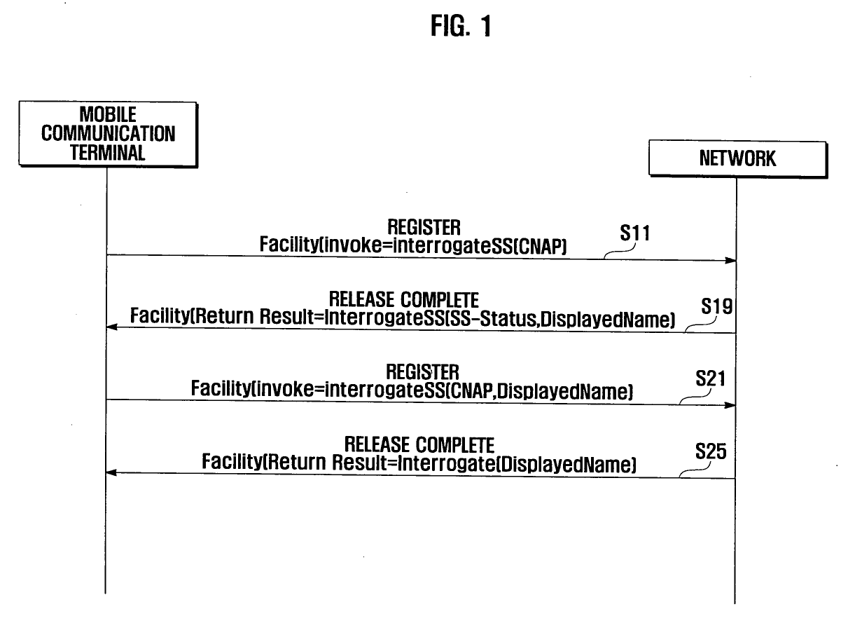

FIG. 1 schematically illustrates a flow of signals in a method for providing a caller information service according to an exemplary embodiment of the present invention.

Referring to FIG. 1, a mobile communication terminal is a mobile terminal capable of performing communication.

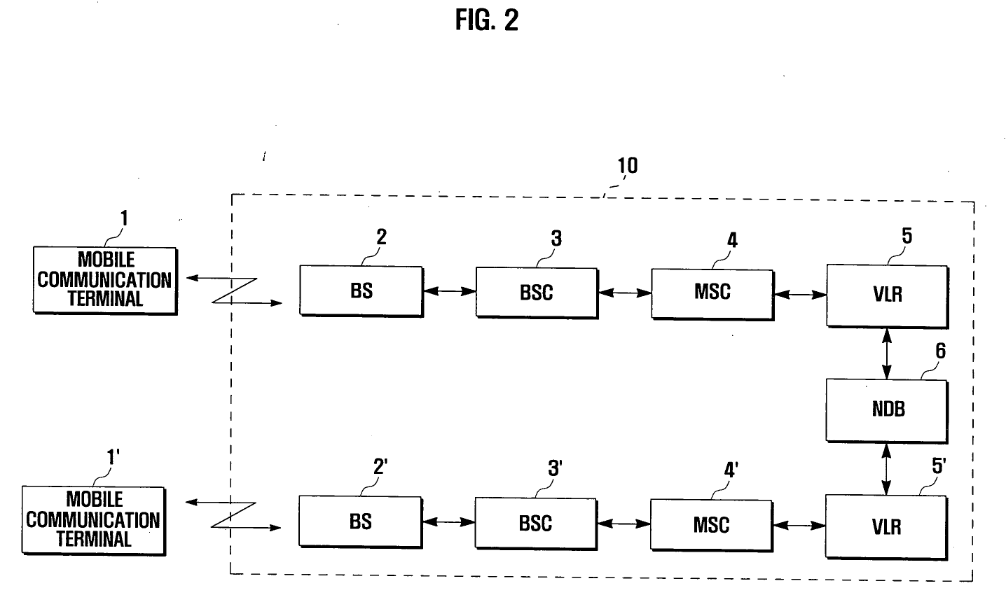

A network refers to a mobile communication network used to interconnect mobile communication terminals through communication. The network comprises at least the elements of a base station (BS), a base station controller (BSC), a mobile switching center (MSC), a visitor location register (VLR), and a home location register. The configuration of the network is described later in more detail with reference to FIG. 2.

A method for providing a caller information service according to an exemplary embodiment of the present invention is described with reference to FIG. 1. Referring to FIG. 1, a mobile communication terminal requests caller information, i.e. information about a Calling Name Presentation (CNAP) service, from a network (S11).

The network then transmits the information about the CNAP service to the mobile communication terminal (S19). The information about the CNAP service contains SS-Status representing subscription to the CNAP service, and DisplayedName representing a calling name associated with the mobile communication terminal.

Thus, a user of the mobile communication terminal can view the calling name currently registered with the network.

If the user of the mobile communication terminal wishes to modify the registered calling name, the mobile communication terminal sends a request for information about the CNAP service together with DisplayedName representing a desired new calling name (S21).

The network then modifies the calling name associated with the mobile communication terminal to register the new calling name and transmits the newly modified calling name to the mobile communication terminal to indicate the completion of registration (S25).

FIG. 2 illustrates a system for providing a caller information service according to another exemplary embodiment of the present invention.

The system for providing a caller information service according to the present invention includes a network comprising BSs 2 and 2′, BSCs 3 and 3′, MSCs 4 and 4′, VLRs 5 and 5′ and a name database (NDB) 6 as described with reference to FIG. 1, and mobile communication terminals 1 and 1′ connected to the network.

The BSs 2 and 2′ communicate with the mobile communication terminals 1 and 1′ respectively, and relay received signals to the mobile communication terminals 1 and 1′.

The BSCs 3 and 3′ control the BSs 2 and 2′ respectively, and enable the mobile communication terminals 1 and 1′ to connect to the network through the BSs 2 and 2′.

The MSCs 4 and 4′ connect to the BSCs 3 and 3′, respectively, set up or terminate calls placed by the mobile communication terminals 1 and 1′, perform various functions associated with call processing and supplementary services, and enable connection to another network. The MSCs 4 and 4′ also serve as an interface between a public switched telephone network (PSTN) and a mobile communication network to provide circuit switching services to subscribers. Further, the MSCs 4 and 4′ manage radio resources and databases of VLRs 5 and 5′, switch circuits between subscribers, relay incoming and outgoing calls, and perform handoff and roaming.

The VLRs 5 and 5′ are databases that store information about the locations of the mobile communication terminals 1 and 1′ that are not under jurisdiction of their home system. The VLRs 5 and 5′ also store information about whether the mobile communication terminals 1 and 1′ subscribe to caller information services. The information can be made available from HLRs (not shown). The HLRs are database centers that hold information about subscribers, locations, and supplementary services relating to the mobile communication terminals 1 and 1′. The HLRs work with the MSCs 4 and 4′ and the VLRs 5 and 5′ to perform call processing, functions related to supplementary services, and cooperate with other switching functions and control the supplementary services.

The NDB 6 stores calling name information about subscribers. Although the NDB 6 is independent of the other components that are shown in FIG. 2, it may nevertheless be incorporated into the HLRs, which are not shown in FIG. 2.

A method for providing a caller information service according to an exemplary embodiment of the present invention is now described in detail. The above-described configuration of the system for providing a caller information service will become more apparent from the following descriptions of a method for providing a caller information service.

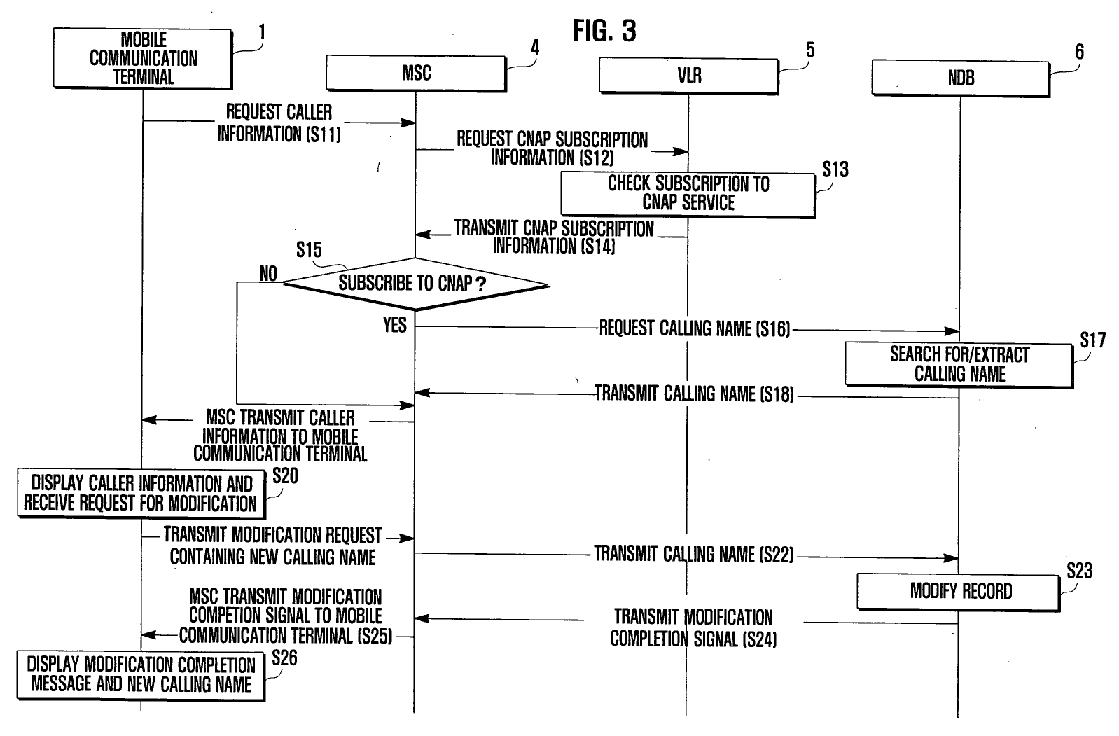

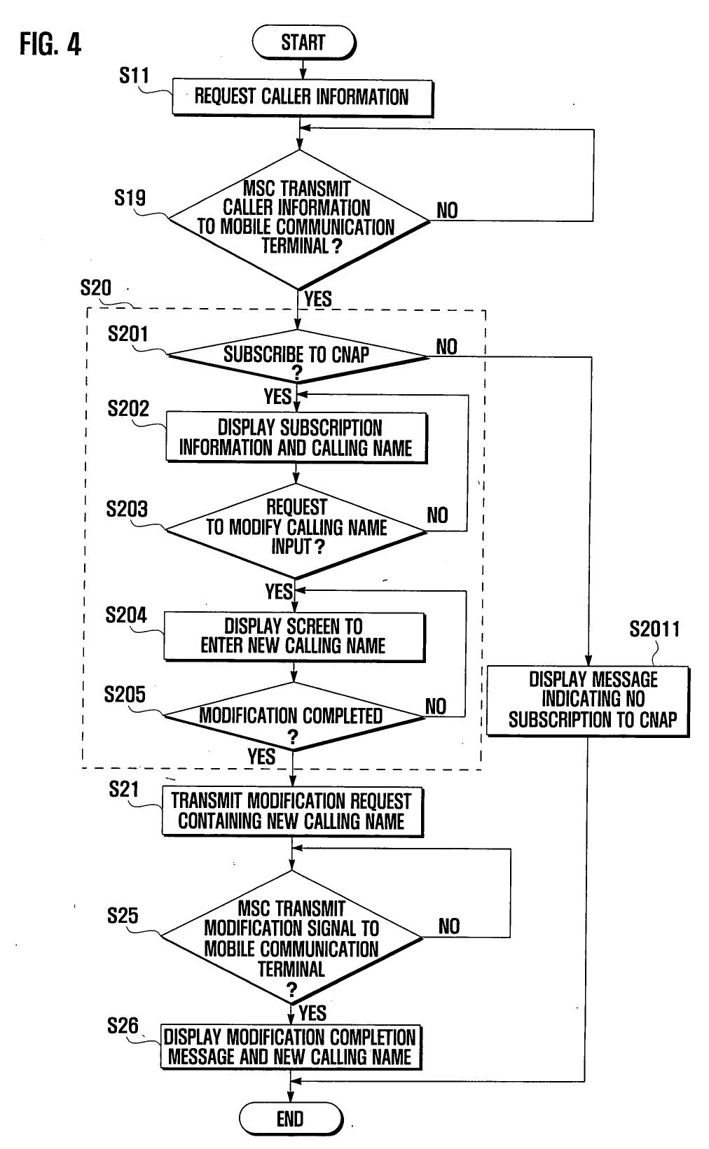

FIG. 3 is a flowchart illustrating a method for providing a caller information service according to another exemplary embodiment of the present invention, and FIG. 4 is a flowchart illustrating a method for providing a caller information service in a mobile communication terminal according to another exemplary embodiment of the present invention.

The method for providing a caller information service according to the present embodiment is described in more detail with reference to FIGS. 1 through 4. Referring to FIGS. 1 through 4, a user sends a request for caller information to the network through the mobile communication terminal 1 (S11).

Upon receipt of the request for the caller information from the mobile communication terminal 1, the MSC 4 of the network at the calling side sends a request for CNAP subscription information to the VLR 5 at the calling side (S12). After checking whether the mobile communication terminal subscribes to a CNAP service (S13), the VLR 5 transmits a response to the request for CNAP subscription information to the MSC 4 (S14).

If the mobile communication terminal 1 subscribes to the CNAP service (S15), the MSC 4 requests a calling name related to the mobile communication terminal 1 from the NDB 6 having calling names stored therein (S16).

The NDB 6 searches for the calling name related to the mobile communication terminal 1 to extract the appropriate calling name (S17). The NDB 6 sends the extracted calling name to the MSC 4 (S18). The MSC 4 then transmits the requested caller information (containing the received CNAP subscription/no subscription information, and the calling name if subscribed to CNAP) to the mobile communication terminal 1 (S19).

After the caller information is received by the mobile communication terminal 1, the mobile communication terminal 1 determines whether it subscribes to the CNAP service based on the caller information (S201). If the caller information received from the MSC4 indicates no subscription to the CNAP service, the mobile communication terminal 1 displays a message notifying the user of no subscription to the CNAP service and terminates the use of the caller information service (S2011).

If the caller information indicates subscription of the mobile communication terminal 1 to the CNAP service at step S201, the mobile communication terminal 1 displays the caller information received from the network, i.e. the CNAP subscription information and the calling name received from the NDB 6 to the user (S202). The mobile communication terminal displays only information indicating subscription/no subscription to a CNAP service, thus enabling a user to confirm subscription/no subscription to the CNAP service. However, the method for providing a caller information service according to the present invention enables the user to view subscription/no subscription to a CNAP service in addition to the calling name displayed to a called party. Thus, the user can view the calling name that is displayed to the called party when placing a call.

If the user desires to modify the displayed calling name, a request for modifying the calling name is input by the user (S203). When the request is input, the mobile communication terminal 1 displays a window that enables the user to enter a desired new calling name (S204). After the new calling name is input (S205), the mobile communication terminal 1 transmits a modification request containing the new calling name to the MSC 4 (S21).

The MSC 4 that has received the new calling name sends a signal indicating a request to modify the previously registered calling name to the NDB 6, together with the new calling name (S22).

Upon receipt of the modification request, the NDB 6 searches the database and extracts a record associated with the mobile communication terminal 1. The NDB 6 modifies the previously registered calling name into the new calling name to store the new calling name (S23).

After completing modification of the calling name, the NDB 6 transmits a modification completion signal to the MSC 4 (S24). The MSC 4 in turn transmits the modification completion signal to the mobile communication terminal 1 (S25).

The mobile communication terminal 1 receives the modification completion signal and displays a message indicating modification of the calling name (S26), preferably, together with the new calling name.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

A method for providing a caller information service in a mobile communication terminal according to the present invention enables users to view a calling name displayed to a called party through their mobile communication terminal according to the user request, and enables the user to easily modify a previously registered calling name into a desired calling name for registration.

While the present invention has been particularly shown and described with reference to embodiments thereof, it will be understood by those of ordinary skill in the art that various changes and modifications in form and details may be made without departing from the spirit and scope of the present invention as defined by the following claims. For example, although in the above description a CNAP service is used, the method and system of the present invention can also be applied in other cases where a user desires to view and modify information about a supplementary service.

As described above, a method and system for providing a caller information service in a mobile communication terminal according to the present invention enable a user to view subscription/no subscription to a caller information service as well as a calling name based on caller information received from a network, and enable the user to easily modify the calling name into a desired calling name for registration.

What is claimed is:

1. A method for providing a caller information service in a mobile communication terminal, comprising the steps of:
requesting caller information containing a calling name registered on a network;
receiving the caller information from the network; and
displaying the caller information.

2. The method of claim 1, wherein the caller information contains information about whether the mobile communication terminal subscribes to the caller information service.

3. The method of claim 2, wherein the caller information service is a Calling Name Presentation (CNAP) service that enables display of the calling name.

4. The method of claim 1, further comprising the step of:
modifying, after displaying the caller information, the caller information to register new caller information.

5. The method of claim 4, wherein the step of modifying the caller information comprises the steps of:
entering a new calling name to replace the calling name;
transmitting the new calling name to the network; and
receiving a signal from the network indicating the completion of information modification.

6. The method of claim 5, further comprising the step of:
displaying, after receiving the information modification completion signal, a message indicating the completion of modification of the calling name.

7. A system for providing a caller information service, comprising:
a mobile communication terminal for requesting previously registered caller information and modification of a calling name contained in the caller information;
a name database (NDB) having a database containing the caller information, wherein the NDB extracts and transmits a calling name associated with the mobile communication terminal upon receiving a request for the caller information, and modifies the calling name according to a request to modify the calling name and stores a new calling name; and
a mobile switching center (MSC) for relaying a signal transmitted between the mobile communication terminal and the NDB, and for checking whether the mobile communication terminal subscribes to the caller information service according to the request received from the mobile communication terminal for the caller information to be transmitted to the mobile communication terminal.

8. The system of claim 7, further comprising:
a visitor location register (VLR) for providing information to the MSC about whether the mobile communication terminal subscribes to the caller information service.

9. The system of claim 7, wherein the caller information contains information about subscription/no subscription to a Calling Name Presentation (CNAP) service.

10. An apparatus for providing a caller information service in a mobile communication terminal, comprising:
a processor in communication with a memory, the processor executing code for:
requesting caller information containing a calling name registered on a network;
receiving the caller information from the network; and
displaying the caller information.

11. The apparatus of claim 10, wherein the caller information contains information about whether the mobile communication terminal subscribes to the caller information service.

12. The apparatus of claim 11, wherein the caller information service is a Calling Name Presentation (CNAP) service that enables display of the calling name.

13. The apparatus of claim 10, wherein the processor further executing code for:
modifying, after displaying the caller information, the caller information to register new caller information.

14. The apparatus of claim 13, wherein the step of modifying the caller information comprises the steps of:
entering a new calling name to replace the calling name;
transmitting the new calling name to the network; and
receiving a signal from the network indicating the completion of information modification.

15. The apparatus of claim 14, wherein the processor further executing code for:
displaying, after receiving the information modification completion signal, a message indicating the completion of modification of the calling name.
